(19) United States
(12) Patent Application Publication
(10) Pub. No.: US 2026/0337027 A1
(43) Pub. Date: Oct. 29, 2026

(54) HEAT INTEGRATED CHEMICAL LOOPING FORMATION OF CARBON AND HYDROGEN

(71) Applicant: Technip Energies France, Nanterre Cedex (FR)

(72) Inventors: Samuel SHANER, Goleta, CA (US); Philip PIPER, Goleta, CA (US); Brett PARKINSON, Goleta, CA (US); Eric W. MCFARLAND, Goleta, CA (US)

(21) Appl. No.: 19/151,024

(22) PCT Filed: Jan. 25, 2024
(86) PCT No.: PCT/US2024/012906

§ 371 Date: Jul. 25, 2025

Related U.S. Application Data
(60) Provisional application No. 63/481,720, filed on Jan. 26, 2023.

(51) Int. Cl. C01B 32/05; C01B 3/40

(52) U.S. Cl. CPC C01B 32/05; C01B 3/40; C01B 2203/0822; C01B 2203/1614; C01B 2203/1628

(57) ABSTRACT

A heat integrated reaction process includes carrying out one or more exothermic reactions to produce heat and form solid carbon from a reactant gas comprising CO, a hydrocarbon, and CO2, transferring at least a portion of the heat from the one or more exothermic reactions to at least one endothermic reaction of one or more endothermic reactions, and carrying out the one or more endothermic reactions using the heat transferred from the one or more exothermic reactions.

### CROSS-REFERENCE TO RELATED APPLICATIONS

The present application claims priority to U.S. Provisional Application No. 63/481,720 filed Jan. 26, 2023 and entitled “HEAT INTEGRATED CHEMICAL LOOPING FORMATION OF CARBON AND HYDROGEN”, the entire disclosure of which is incorporated herein by reference.

### BACKGROUND

Industrial hydrogen can be produced primarily by reacting hydrocarbon feedstocks (e.g. CH₄, naphtha, biomass, coal, etc) with oxygen-containing species (e.g. O₂, H₂O, CO₂) to produce a desired mixture of H₂, CO₂, and H₂O. Overall the carbon input to the system exits as CO₂, which is typically released to the environment or, in future scenarios, geologically sequestered. This results in significant additional costs resulting from CO₂ handling and sequestration process costs, a carbon tax, or a negative externality on society (e.g., climate change).

### SUMMARY

In some embodiments, a heat integrated reaction process comprises carrying out one or more exothermic reactions to produce heat and form solid carbon from a reactant gas comprising CO, a hydrocarbon, and CO₂, transferring at least a portion of the heat from the one or more exothermic reactions to at least one endothermic reaction of one or more endothermic reactions, and carrying out the one or more endothermic reactions using the heat transferred from the one or more exothermic reactions.

In some embodiments, a system to convert hydrocarbons to solid carbon and hydrogen comprises a first reactor configured to at least partially convert hydrocarbons with H₂O and/or CO₂ to a first product stream comprising CO, CO₂, H₂O, and H₂, a second reactor configured to receive the first product stream and further convert the first product stream to produce a second product stream, and a third reactor configured to receive the second product stream, carry out an exothermic reaction and convert at least a portion of CO and CO₂ in the second product stream to solid carbon. At least a portion of the heat released in the exothermic reaction is transferred to the first reactor.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description:

FIG. 1 schematically illustrates an integration of exothermic and endothermic reactions according to some embodiments.

FIG. 2 schematically illustrates a carbon formation system according to some embodiments.

FIG. 3 schematically illustrates another carbon formation system according to some embodiments.

### DETAILED DESCRIPTION

Disclosed herein are systems and methods for integrating an exothermic reaction that produces solid carbon and/or metal carbides from carbon monoxide and/or carbon dioxide and an endothermic reaction. The systems and methods described herein are based on transformation of hydrocarbon materials such as natural gas or other molecules or mixtures of molecules containing predominately hydrogen and carbon atoms into a solid carbon product that can be readily handled and prevented from forming carbon oxides in the atmosphere, as well as a gas phase co-product (e.g., hydrogen, unreacted hydrocarbons, other pyrolysis products, etc.) and water. In some embodiments, the gas-phase co-product, hydrogen, can be used as a fuel or chemical.

A key challenge with two step processes that produce solid carbon, hydrogen, and water from a hydrocarbon feedstock via an intermediate carbon oxide gas is that the hydrocarbon conversion reactions tend to be endothermic while all carbon forming reactions from carbon oxide gases are strongly exothermic. For example, the steam methane reforming reaction and the CO reduction reaction have standard heats of reaction of 206 kJ/mol CH₄ and −131 kJ/mol CO, respectively. The overall energy efficiency of a process will be low if the heat from the exothermic reaction is not used to drive the endothermic reactions forward or other beneficial uses (e.g. produce steam to drive a turbine and generate electricity). Various considerations including the temperature and pressure, use of catalysts, and reactor design for both reactions need to be taken into consideration to achieve sufficient reaction kinetics and thermodynamic equilibrium conversions such that heat from the exothermic reaction can drive conversion of endothermic reaction in a practical reactor design.

Disclosed herein is a process design for coupling of exothermic carbon producing reactions from carbon oxide gases to one of several endothermic reactions. The exothermic carbon producing reactions from carbon oxide gases can include:

$$CO + {H}_{2} \to C + {H}_{2} O \qquad {ΔH}^{o} = - 131 \frac{kJ}{mol CO} ( CO reduction reaction )$$

$${CO}_{2} + 2 {H}_{2} \to C + 2 {H}_{2} O \qquad {ΔH}^{o} = - 90 \frac{kJ}{mol CO} ( {CO}_{2} reduction reaction )$$

$$2 CO \to C + {CO}_{2} \qquad {ΔH}^{o} = - 172 \frac{kJ}{mol {CO}_{2}} ( Boudouard reaction )$$

The endothermic reactions can produce H₂ and/or CO that can be used to convert carbon oxides to carbon via one of the exothermic reactions. The endothermic reactions can include:

$${CH}_{4} + {H}_{2} O \to CO + 3 {H}_{2} \qquad {ΔH}^{o} = 206 \frac{kJ}{mol {CH}_{4}} ( Steam methane reforming )$$

$$\begin{matrix}{CH}_{4} + {CO}_{2} \to \\ 2 CO + 2 {H}_{2}\end{matrix} \qquad {ΔH}^{o} = 247 \frac{kJ}{mol {CH}_{4}} ( dry reforming of methane )$$

$${CH}_{4} \to C + 2 {H}_{2} \qquad {ΔH}^{o} = 76 \frac{kJ}{mol {CH}_{4}} ( pyrolysis )$$

$${CO}_{2} + {H}_{2} \to CO + {H}_{2} O \qquad {ΔH}^{o} = 41 \frac{kJ}{mol {CO}_{2}} ( Reverse water gas shift )$$

$${H}_{2} O + C \to CO + {H}_{2} \qquad {ΔH}^{o} = 131 \frac{kJ}{mol CO} ( steam gasification of carbon )$$

$${CO}_{2} + C \to 2 CO \qquad {ΔH}^{o} = 172 \frac{kJ}{mol {CO}_{2}} ( reverse Boudouard reaction )$$

The thermal coupling of the exothermic reacting gas stream 1 and endothermic reacting gas stream 2 can occur in one of several ways. First, stream 2 can pass through conduits or tubes in the exothermic reactor (e.g. a fluidized bed reactor) whereby heat from stream 1 and/or media within the reactor can be readily transferred to stream 2. The endothermic reaction can occur while heat is being transferred to the gas and/or after the heat has been transferred. In some instances, it can be advantageous to perform the endothermic reaction in a separate location as the endothermic reaction can be kinetically slow and would require excess volume within the exothermic reactor to achieve acceptable conversion.

Alternatively, stream 1 can transfer heat to stream 2 after stream 1 has exited the exothermic reactor in either a dedicated heat exchanger and/or within a vessel where the endothermic reactions are occurring. This can be advantageous when integrating tubes into the exothermic reactor is difficult.

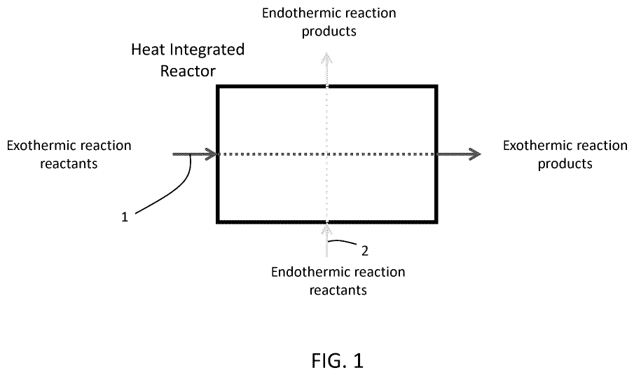

FIG. 1 illustrates a schematic illustration of the thermal integration of one or more exothermic reactions that can form solid carbon from a gas comprising carbon such as carbon monoxide, carbon dioxide, and/or a hydrocarbon (e.g., methane, etc.), and one or more endothermic reactions. The exothermic reaction can use the exothermic reactant and product stream 1, while the endothermic reaction can use the endothermic reactant and product stream 2. The heat released by the exothermic reaction can be transferred to the endothermic stream 2 within the exothermic reactor itself, using a heat exchanger that is external to the endothermic and exothermic reactors, and/or within the endothermic reactor.

As noted herein, the exothermic reaction can form solid carbon from a carbon containing gas such as a hydrocarbon, carbon dioxide, and/or carbon monoxide. In some aspects, the hydrocarbon gas can comprise methane and/or natural gas, though any suitable hydrocarbon can be used. For example, the hydrocarbon can comprise a light alkane such as methane, ethane, natural gas, as well as other gaseous, liquid, solid hydrocarbons (e.g. alcohols, crude oil, plant oils, biomass, naphtha, etc.), and any mixtures thereof. In some aspects, a gasification reactor can be used to convert one or more hydrocarbon containing species into a gaseous stream of hydrocarbons for further processing.

The exothermic reaction can occur under any suitable conditions and in any suitable reactor configurations. In some aspects, the exothermic reactions can occur in a fluidized bed reactor, a moving bed reactor, a spouting bed reactor, a fixed bed reactor, or the like. In general, the exothermic reactions can occur at a temperature between about 400 °C to about 1000 °C, or between about 500 °C to about 750 °C, and at a pressure between about 1-50 bar.

In some aspects, a heterogeneous catalyst can be used in the exothermic reactor. The exothermic reactor can use a catalyst to promote the reactions and the formation of solid carbon. The catalyst material can include any material suitable for catalyzing the formation of the solid carbon material from the carbon oxide and the gaseous reducing material. As an example, the catalyst material may be an element of Group VI, Group VII, or Group VIII of the Periodic Table of Elements (e.g., iron, manganese, silicon, magnesium, calcium, sodium, aluminum, titanium, nickel, molybdenum, platinum, palladium, rhodium, ruthenium, chromium, cobalt, tungsten, etc.), an actinide, a lanthanide, oxides thereof, alloys thereof, or combinations thereof. Any metal known to be subject to metal coking may also be suitable for use as the catalyst material.

The catalyst can be provided within the exothermic reactor (e.g., within the reaction chamber) as one or more solid structures (e.g., a particle, a wafer, cylinder, plate, sheet, sphere, pellet, mesh, fiber, etc.), and/or as at least a partial coating on another structure (e.g., particles of the at least one material deposited on a structure, such as a wafer, cylinder, plate, sheet, sphere, mesh, pellet, etc.) within the reactor vessel. In some embodiments, the catalyst material may be provided within the exothermic reactor as a plurality of particles or particulates. The catalyst material may be stationary (e.g., as a catalyst bed) or mobile (e.g., as a fluidized bed) within the reactor. In some embodiments, a portion of the catalyst material may be mobile within the reactor and another portion of the catalyst material may be stationary within the reactor.

The exothermic reactions can include any reaction capable of forming solid carbon from a carbon containing gas such as a hydrocarbon, carbon monoxide, and/or carbon dioxide. Suitable exothermic reactions can include, but are not limited to, a CO reduction reaction, a Boudouard reaction, a CO₂ reduction reaction, and/or a hydrocarbon oxidation reaction with carbon formation (e.g., methane reacting with oxygen to produce solid carbon, and carbon monoxide, carbon dioxide, and/or water).

As noted herein, the endothermic reactions can occur using at least a portion of the heat provide by the exothermic reactions. In some embodiments, the endothermic reactions can produce one or more products used in the exothermic reactions to produce solid carbon. For example, the endothermic reactions can produce carbon monoxide, hydrogen, and water from reactant comprising a hydrocarbon, water, carbon dioxide, hydrogen, and solid carbon. When a hydrocarbon reactant is used in an endothermic reaction, the hydrocarbon can include any of those described herein, and may be the same or different than a hydrocarbon used in an exothermic reaction.

The endothermic reaction(s) can occur under any suitable conditions and in any suitable reactor configurations. In some aspects, the endothermic reactions can occur in a fluidized bed reactor, a moving bed reactor, a spouting bed reactor, a fixed bed reactor, or the like. In general, the endothermic reactions can occur at a temperature between about 400 °C to about 1000 °C, or between about 500 °C to about 750 °C, and at a pressure between about 1-50 bar. In some aspects, the endothermic reaction(s) can occur at greater pressure, a lesser pressure, or substantially the same pressure the pressure of the exothermic reaction(s).

The endothermic reactions can include, but are not limited to, a steam methane reforming reaction, a dry reforming reaction, a hydrocarbon pyrolysis reaction, a reverse water gas shift reaction, steam gasification of carbon, and/or a reverse Boudouard reaction.

In some aspects, endothermic reaction(s) can comprise a steam methane reforming (SMR) reaction carried out in an SMR unit. An SMR unit can carry out the reaction of water with a hydrocarbon feed to form CO and H₂. An exemplary SMR reaction using methane as an example can proceed according to the following:

CH₄+H₂O↔CO+3H₂

The SMR unit can carry out the reforming reaction in a reactor vessel, which can contain a catalyst to improve the reforming reaction rates. The hydrocarbon feed can comprise any of the hydrocarbon feeds as described herein such as methane. The feed to the SMR unit can also comprise steam. In some embodiments, the reformer can comprise any suitable reactor, such as for example a tubular reactor, a multitubular reactor, and the like, or combinations thereof.

In some embodiment, the SMR unit can comprise a nickel-based catalyst (e.g., sulfur sensitive nickel-based catalyst) and/or a sulfur passivated nickel-based catalyst (to avoid carbon depositions). The reforming reaction for hydrocarbons such as methane can be endothermic, and a reaction rate depends on the temperature, pressure and catalyst type. The endothermic nature of the reforming reaction can be balanced with the exothermic reaction based on the reaction of oxygen with the hydrocarbon such that the overall reaction is autothermal or substantially autothermal. The hydrocarbon can undergo the reforming reaction at high temperatures, however, in the presence of a catalyst (e.g., nickel-based catalyst), the temperature at which the hydrocarbon can be reformed can be lowered. The SMR reaction can be carried out at a temperature between about 700 °C to about 1100 °C, or from about 800 °C to about 900 °C. In an embodiment, the reformer can be characterized by a reforming pressure of from about 1 bar to about 50 bars.

In some aspects, the endothermic reactions can comprise a dry reforming of methane (DRM) reaction. Dry reforming of a hydrocarbon occurs according to the reaction:

CH₄+CO₂↔2CO+2H₂

A DRM unit can carry out the reforming reaction in a reactor vessel, which can contain a catalyst to improve the reforming reaction rates. The reactor can take a variety of forms such as a fixed bed reactor, a fluidized bed reactor, a moving bed reactor, or the like. The hydrocarbon feed can comprise a hydrocarbon such as methane and carbon dioxide in equimolar amounts or nearly equimolar amounts. While described as comprising methane, other hydrocarbon containing streams can also be used including any of those described herein. A DRM unit may operate free of water or substantially free of water.

A DRM unit may optionally operate in the presence any suitable catalyst(s). Exemplary catalysts can include supported or bulk catalyst containing Group VIII (Columns 8-10) metals that are catalytically active towards reforming reactions. By way of example, nickel, rhodium, ruthenium, or platinum or any combination thereof based catalysts can be used in dry methane reforming.

The reaction conditions within a DRM may include a pressure of between about 1 bar to about 50 bar, or between about 1 bar to about 20 bar, a temperature of about 750 °C to about 1100 °C, or between about 800 °C to about 950 °C, and a GHSV of about 500 h⁻¹ to about 100,000 h⁻¹. In some embodiments, the hydrocarbon (e.g., methane, etc.) conversion in the reaction can be about 60% to about 80%. The hydrogen gas to carbon monoxide ratio (H₂/CO) in the product stream leaving the DRM unit can range from about 0.5 to about 1. In addition, some amount of unreacted hydrocarbon gas and carbon dioxide can also be present depending on the overall conversion.

In some embodiments, the endothermic reaction(s) can include a reverse water gas shift (rWHS) reaction. The rWGS reactor can convert CO₂ to CO using H₂ according to the following equation:

CO₂+H₂↔CO+H₂O

The rWGS reaction can be operated in the presence of one or more catalysts. Suitable catalyst can include those selected from the group consisting of ZnO, MnOₓ, alkaline earth metal oxides composite (or mixed metal) oxides. Further rWGS catalysts are known in the art.

The rWGS reaction can be carried out in one or more suitable reactors such as an adiabatic or heated reactor. Reactor vessels such as fixed bed reactors, fluidized bed reactors, or the like can be used. For example, the rWGS reactor can comprise a fixed bed catalyst disposed in one or more tubular reactors configured in an adiabatic reactor or in a heat reactor with the tubular reactors being externally heated. The rWGS reactor can be operated at a temperature in a range of from about 500 °C to about 800 °C, and any suitable pressure used within the system such as between about 1 bar to about 50 bar, or between about 5 bar and about 20 bar. The conversion efficiency of CO₂ to CO can be above 30%.

In some embodiments, the endothermic reaction(s) can include a steam gasification reaction. Gasification involves a thermal processing of a carbon feedstock with an oxidant stream to produce a synthesis gas. Steam gasification can use water as the oxidant to react with carbon to produce carbon monoxide and hydrogen as a synthesis gas mixture. Steam gasification can be represented by the following equation:

H₂O+C->CO+H₂

The gasification can be carried out in any suitable reaction vessel. The reactor, based on gas velocities and configuration, may be fixed bed, fluidized bed or entrained flow gasifiers or some variation of these. The types and extent of reactions in a gasifier depends upon design and operating conditions in the gasifier. The temperature of the steam gasification process may be between about 800 °C and about 1500 °C.

In some embodiments, the endothermic reaction(s) can include a reverse Boudouard reaction. The reverse Boudouard reaction (RBR) can be used to produce CO from CO₂ and solid carbon. The RBR can be represented by the following equation:

CO₂+C→2CO

The RBR can be used in any suitable reactor, and can use a catalyst. In some aspects, the RBR reactions can occur in a fluidized bed reactor, a moving bed reactor, or a fixed bed reactor, or the like. In general, the RBR reactions can occur at a temperature between about 600 °C to about 1200 °C.

In the RBR, CO₂ can be combined with carbon and transformed into carbon monoxide, which is thermodynamically favored at high temperature. Various catalyst can be used such as iron based catalysts, which can be disposed on elemental carbon supports. Alkali carbonates have also been used to catalyze char gasification by CO₂. Additional catalysts can include mixed metal oxides with nickel, ceria, and zirconia. The overall RBR reaction than can produce a carbon monoxide stream for further use in the system.

While described as separate reactions, one or more of the endothermic reactions may occur in the same reactor at the same time, depending on the composition of the reactants and products present as well as the reaction conditions and catalyst used, if any.

The integration of the exothermic reactions and endothermic reactions can be used in a process and system to convert hydrocarbons to solid carbon and hydrogen. The process and system can use a plurality of reactors for carrying out the reactions. A first reactor can be used to convert a feed comprising hydrocarbons with H₂O and/or CO₂ to CO, CO₂, H₂O, and H₂ to produce a partially reacted product stream. A second reactor can be used further convert the partially reacted product stream from the first reactor to produce an intermediate stream. The intermediate stream can comprise water and hydrogen among other components. Some portion of the water and hydrogen can optionally be removed from the intermediate stream before it can pass to a third reactor. Within the third reactor, the carbon monoxide and carbon dioxide can react exothermically to form solid carbon and other reaction products. The resulting heat released in the third reactor can then be used for the reaction in the first reactor. For example, the heat can be transferred to the first reactor itself and/or to one or more streams entering the first reactor. In some aspects, the second reactor can be heated using a combustion source such as hydrogen produced in the system, thereby avoiding the formation of carbon oxides due to combusting hydrocarbons.

The hydrocarbon used in the system can include any of the hydrocarbons or hydrocarbon mixtures described herein such as light alkanes such as methane, ethane, natural gas, as well as other gaseous, liquid, solid hydrocarbons (e.g. alcohols, crude oil, plant oils, biomass, naphtha, etc.), and any mixture thereof. The plurality of reactors can operate under any suitable conditions such as at a pressure between about 1 bar to about 50 bar, or between about 5 bar to about 20 bar. In some aspects, the first and second reactors can operate at a different pressure than the third reactor. The first and third reactors can operate at a temperature between about 400 °C and about 1000 °C.

The third reactor can be a carbon formation reactor that can be configured in any suitable configuration. In some aspects, the third reactor can comprise a mobile bed (e.g., fluidized bed, spouting bed, ebullient bed, moving bed, etc.) of particles that can be catalytic and/or non-catalytic. In some aspects, the third reactor can comprise a fluidized bed comprising catalytic particles. The catalyst can comprise one or more catalytic components including any of those described herein such as Fe, Mn, Co, Ni, Si, Mg, Ca, Na, Al, Ti, Pt, Pd, Rh, and/or Ru. The first and second reactors can comprise catalysts for converting the hydrocarbons, where the catalyst can be selected based on the specific endothermic reactions being carried out, including any of those described herein for the specific reactions. In some aspects, the first and/or second reactor can comprise a catalyst comprising one or more of Fe, Mn, Co, Ni, Si, Mg, Ca, Na, Al, Ti, Pt, Pd, Rh, and/or Ru.

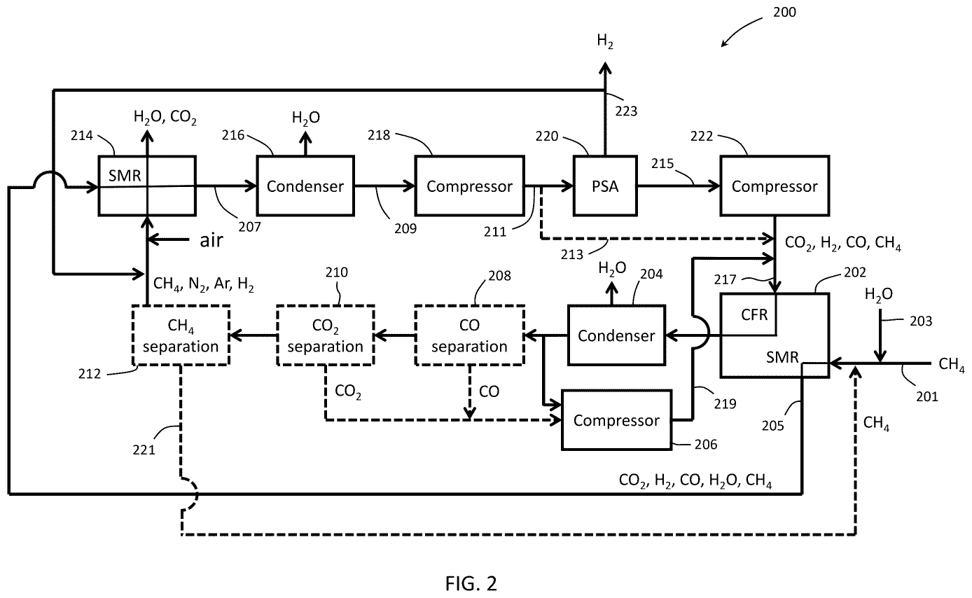

An embodiment of a system and associated process for converting hydrocarbons to solid carbon and hydrogen is illustrated in FIG. 2. As shown, a plurality of reactors such as the heat integrated reactor 202 and a second reactor 214 can be coupled to allow for the conversion of hydrocarbons to solid carbon with the production of hydrogen. As shown, a hydrocarbon stream 201 comprising one or more hydrocarbons, a water stream 203 comprising water, and optionally a recycle stream 221 comprising separated hydrocarbons can pass to a first reaction or reactor as part of the heat integrated reactor 202 that can be used to form a product stream 205 containing CO₂, H₂, CO, H₂O while also containing some amount of unreacted components of the feed stream such a portion of the hydrocarbon(s) and water. The hydrocarbon stream can comprise any of the hydrocarbons described herein. The SMR reaction occurring with the heat integrated reactor 202 can occur using the conditions, catalysts, and reactors as described herein with respect to the SMR process.

The heat integrated reactor 202 is illustrated as a single reactor that comprise a plurality of reactor passes such as a SMR conversion pass for the conversion of the hydrocarbon feed stream with H₂O and/or CO₂ to CO, CO₂, H₂O, and H₂ to produce a partially reacted product stream. A second reactor pass can include a carbon formation reaction to produce solid carbon and hydrogen. While the heat integrated reactor 202 is shown as a single unit operation with the two reactions thermally coupled, the heat integrated reactor 202 can comprise a single vessel with separated reactions and/or separate vessels that are thermally coupled using various heat exchanger configurations.

The product stream 205 can pass to the second reactor 214 that can be used further convert the components of the product stream 205 to produce an intermediate stream 207. The intermediate stream 207 can comprise water and hydrogen among other components. The second reactor 214 can carry out a further SMR reaction on the product stream 205 to produce the intermediate stream. The SMR reaction occurring with the second reactor 214 can occur using the conditions, catalysts, and reactors as described herein with respect to the SMR process, and the conditions and catalysts within the second reactor 214 can be the same or different than those occurring in the SMR reaction in the heat integrated reactor 202.

Since the reaction within the second reactor 214 is endothermic, a heat source can be provided to add heat to a stream entering the reactor and/or within the reactor. In some aspects, a combustion reaction can be used to combust a fuel source to produce the heat used within the endothermic reaction in the second reactor 214. While shown as combusting a hydrocarbon with air in FIG. 2, other combustion sources such as using hydrogen to combust with air or an oxygen stream can also be used. Various sources for the fuel can be used such as unreacted hydrocarbons from an optional hydrocarbon separation process 212 and/or separated hydrogen in stream 223.

The resulting intermediate stream 207 can pass to a condenser 216 to remove at least a portion of the water in the intermediate stream 207. The condenser 216 can cool the intermediate stream 207 to between 0 °C to 50 °C, or to less than 30 °C to condense at least a portion of the water, which can be removed as a liquid stream.

The remaining gas phase components from the condenser 216 can pass as stream 209 to compressor 218 to be pressurized upstream of the separation unit 220. The resulting compressed stream 211 may pass entirely to the separator 220, or optionally all or a portion of the stream can pass as bypass stream 213 to an inlet of the carbon formation reaction in the heat integrated reactor 202.

The separator 220 can serve to separate at least a portion of any hydrogen in the stream 211. The stream 211 can comprise CO₂, H₂, CO, and unreacted hydrocarbons with a minor amount of water remaining. The hydrogen in the stream 211 can be removed in the separator 220 to form hydrogen stream 223. As shown in FIG. 2, a pressure swing adsorption (PSA) unit can be used to separate at least a portion of the hydrogen from the stream 211 from condenser 216. While shown as a PSA unit, other suitable separation units such as temperature swing adsorption, membrane units, and the like can also be used to separate at least a portion of the hydrogen. In some aspects, at least about 50%, at least about 60%, at least about 70%, at least about 80%, or at least about 90% of the hydrogen (by volume) in the stream 211 from the condenser 216 can be separated in the separation unit 220 to form the hydrogen product stream 223 and a stream 215 having a reduced hydrogen concentration.

The stream 215 can then pass through a compressor 222 prior to passing to the heat integrated reactor 202. The stream leaving the compressor can comprise predominantly CO₂, CO, and unreacted hydrocarbons with some minor amounts of hydrogen, water, and trace components remaining. An optional amount of the intermediate stream taken downstream of the condenser 216 and compressor 218 may be added into the stream from compressor 222 along with some amount of a recycle stream 219 to form the feed stream 217 to the carbon formation reactor portion of the heat integrated reactor 202. The relative amounts of the bypass stream 213 and the recycle stream 219 added into the stream from compressor 222 can be based on the amount of CO, CO₂, hydrocarbons, and H₂ in each stream so that the relative amounts of each components can be controlled in the carbon formation reaction.

Within the heat integrated reactor 202, carbon monoxide and carbon dioxide can react exothermically to form solid carbon and other reaction products. The resulting heat released in the carbon formation reactor can then be used for the reaction in the SMR reaction as part of the heat integrated reactor 202. For example, the heat can be transferred to the first reactor itself and/or to one or more streams entering the first reactor. The exothermic reactions in the carbon formation reactor can include any of the exothermic reactions described herein, including the reaction conditions and catalysts described herein. The solid carbon can be removed using various downstream solid separators such as cyclones, bag houses, and the like. Alternatively, all or a portion of the solids may be removed by gravity from the heat integrated reactor 202. The gas phase products can then pass out of the heat integrated reactor 202 for downstream processing.

The heat integrated reactor 202 can comprise heat integration between the exothermic carbon formation reaction and the endothermic SMR reaction. In some aspects, the two reactions can be carried out at least partially within a single vessel. For example, the endothermic reaction can be carried out in conduits or tubes with a reaction vessel carrying out the exothermic carbon formation reaction, or the exothermic reaction can occur in the conduits and tubes while the SMR reaction occurs in the reaction vessel. In some aspects, the heat from the carbon formation reaction can be transferred to the endothermic reaction using a separate heat exchanger to transfer heat from the products of the exothermic reaction to the reactants of the endothermic reaction prior to the reactants entering a separate reactor vessel. In still other configurations, the heat from the carbon formation reaction can be transferred to the endothermic reaction using heat exchange surfaces within the endothermic reactor to transfer heat from the products of the exothermic reaction to the endothermic reactor vessel. In any of these configurations, heat from the exothermic reaction that produces solid carbon can be transferred to an endothermic reaction.

The gas phase products from the carbon formation reaction can pass out of the heat integrated reactor 202 to a condenser 204. The condenser 204 can cool the product stream to condense at least a portion of the water. If any solids are present in the gas phase stream (e.g., the solid carbon, catalyst particles, heat carrier particles, etc.), one or more solid separators can be used between the carbon formation reaction and the condenser 204. The remaining gas phase products from the condenser can pass to an optional separation train, and/or pass back to a compressor to recompress the gas phase components before returning then in recycle stream 219 back to the inlet of the carbon formation reactor.

When the optional separation train is used, all or a portion of the gas phase products can pass to a CO separation unit 208. The separated CO can be recycled to the compressor 206. The remaining gas phase components can pass to a CO₂ separation unit 210, which can return the captured CO₂ back to the compressor 206. The CO separation unit 208 and the CO₂ separation unit 210 can comprise any suitable units configured to separate CO and/or CO₂, where the CO separation unit 208 and the CO₂ separation unit 210 can be combined in a single unit in some embodiments. Various units such as solvent based contactors can be used to separate CO and/or CO₂ from the gas phase product stream.

The remaining gas phase products may generally comprise unreacted hydrocarbons with some trace amounts of water, CO, CO₂, and H₂. A hydrocarbon separation unit 212 can be used to purify the hydrocarbons, which can then be used as fuel to the second reactor 214 and/or returned to the inlet of the process as a feed to the first SMR reactor as part of the heat integrated reactor 202.

Overall, the system 200 and corresponding process as shown in FIG. 2 can be used to convert a hydrocarbon to solid carbon and hydrogen while integrating the heat from one or more exothermic reactions that produce solid carbon with endothermic reactions used to produce the intermediates in the conversion process.

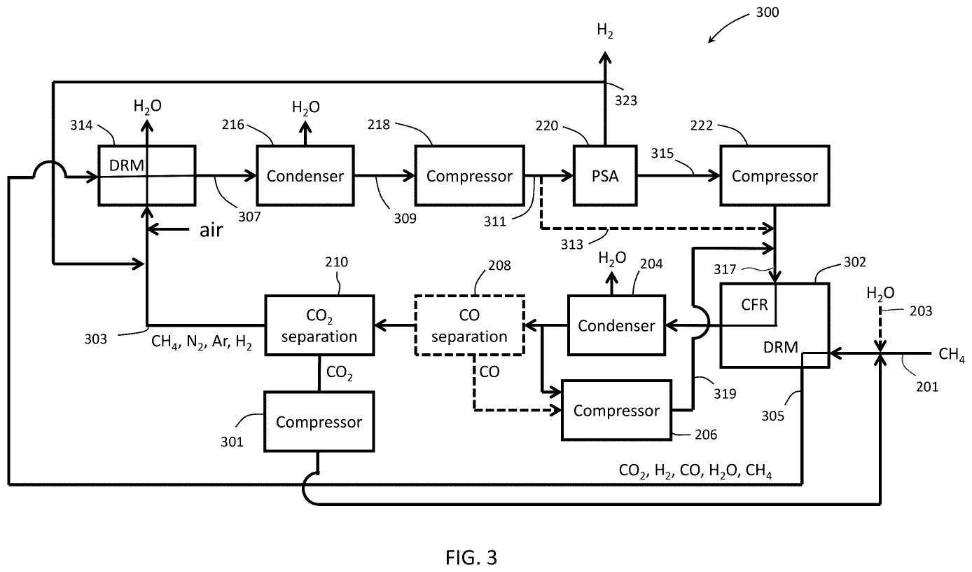

A similar system 300 and corresponding process are shown in FIG. 3. The same or similar units or components will not be re-described in detail in the interest of brevity. Components with the same reference numbers can be the same or similar to those described with respect to FIG. 2. The system 300 can be used to heat integrate a system using a DRM reaction with a carbon formation reaction to produce solid carbon and hydrogen. As shown, a plurality of reactors such as the heat integrated reactor 302 and DRM reactor 314 can be coupled to allow for the conversion of hydrocarbons to solid carbon with the production of hydrogen. As shown, a hydrocarbon stream 201 comprising one or more hydrocarbons, an optional water stream 203 comprising water, and optionally a recycle stream comprising CO₂ can pass to a first reaction or reactor as part of the heat integrated reactor 302 that can be used to form a product stream 305 containing CO₂, H₂, CO, H₂O while also containing some amount of unreacted components of the feed stream such a portion of the hydrocarbon(s) and water. The system is similar to the system 200 except that a DRM reaction can be used in place of an SMR reaction. The hydrocarbon stream can comprise any of the hydrocarbons described herein. The DRM reaction occurring with the heat integrated reactor 302 can occur using the conditions, catalysts, and reactors as described herein with respect to the DRM process.

The heat integrated reactor 302 is illustrated as a single reactor that comprise a plurality of reactor passes such as a DRM conversion pass for the conversion of the hydrocarbon feed stream with CO₂ to CO, CO₂, H₂O, and H₂ to produce a partially reacted product stream. A second reactor pass can include a carbon formation reaction to produce solid carbon and hydrogen. While the heat integrated reactor 302 is shown as a single unit operation with the two reactions thermally coupled, the heat integrated reactor 302 can comprise a single vessel with separated reactions and/or separate vessels that are thermally coupled using various heat exchanger configurations.

The product stream 305 can pass to a second reactor 314 that can be used further convert the components of the product stream 305 to produce an intermediate stream 307. The intermediate stream 307 can comprise water and hydrogen among other components (e.g., CO, CO₂, H₂, etc.). The second reactor 314 can carry out a further DRM reactor on the product stream 305 to produce the intermediate stream 307. The DRM reaction occurring with the reactor 314 can occur using the conditions, catalysts, and reactors as described herein with respect to the DRM process, and the conditions and catalysts within the reactor 314 can be the same or different than those occurring in the DRM reaction in the heat integrated reactor 302.

Since the reaction within the reactor 314 is endothermic, a heat source can be provided to add heat to a stream entering the reactor and/or within the reactor. In some aspects, a combustion reaction can be used to combust a fuel source to produce the heat used within the endothermic reaction in reactor 314. While shown as combusting a hydrocarbon with air in FIG. 3, other combustion sources such as using hydrogen to combust with air or an oxygen stream can also be used. Various sources for the fuel can be used such as unreacted hydrocarbons remaining after CO and CO₂ removal from the carbon formation reaction and/or separated hydrogen in stream 323.

The resulting intermediate stream 307 can pass to a condenser 216 to remove at least a portion of the water in the intermediate stream 307. The condenser 216 can cool the intermediate stream 307 to between 0 °C to 5 °C, or to less than 3 °C to condense at least a portion of the water, which can be removed as a liquid stream.

The remaining gas phase components from the condenser 216 can pass as stream 309 to compressor 218 to be pressurized upstream of the separation unit 220. The resulting compressed stream 311 may pass entirely to the separator 220, or optionally all or a portion of the stream can pass as bypass stream 313 to an inlet of the carbon formation reaction in the heat integrated reactor 302.

The separator 220 can serve to separate at least a portion of any hydrogen in the stream 311. The stream 311 can comprise CO₂, H₂, CO, and unreacted hydrocarbons with a minor amount of water remaining. The hydrogen in the stream 311 can be removed in the separator 220 to form hydrogen stream 323. As shown in FIG. 3, a PSA unit can be used to separate at least a portion of the hydrogen from the stream 311 from condenser 216. While shown as a PSA unit, other suitable separation units such as temperature swing adsorption, membrane units, and the like can also be used to separate at least a portion of the hydrogen.

The stream 315 can then pass through a compressor 222 prior to passing to the heat integrated reactor 302. The stream leaving the compressor 222 can comprise predominantly CO₂, CO, and unreacted hydrocarbons with some minor amounts of hydrogen, water, and trace components remaining. An optional amount of the intermediate stream taken downstream of the condenser 216 and compressor 218 may be added into the stream from compressor 222 along with some amount of a recycle stream 319 to form the feed stream 317 to the carbon formation reactor portion of the heat integrated reactor 302. The relative amounts of the bypass stream 313 and the recycle stream 319 added into the stream from compressor 222 can be based on the amount of CO, CO₂, hydrocarbons, and H₂ in each stream so that the relative amounts of each components can be controlled in the carbon formation reaction.

Within the heat integrated reactor 302, carbon monoxide and carbon dioxide can react exothermically to form solid carbon and other reaction products. The resulting heat released in the carbon formation reactor can then be used for the reaction in the DRM reaction as part of the heat integrated reactor 302. For example, the heat can be transferred to the first reactor itself and/or to one or more streams entering the first reactor. The exothermic reactions in the carbon formation reactor can include any of the exothermic reactions described herein, including the reaction conditions and catalysts described herein. The solid carbon can be removed using various downstream solid separators such as cyclones, bag houses, and the like. Alternatively, all or a portion of the solids may be removed by gravity from the heat integrated reactor 302. The gas phase products can then pass out of the heat integrated reactor 302 for downstream processing.

The heat integrated reactor 302 can comprise heat integration between the exothermic carbon formation reaction and the endothermic DRM reaction. In some aspects, the two reactions can be carried out at least partially within a single vessel. For example, the endothermic reaction can be carried out in conduits or tubes with a reaction vessel carrying out the exothermic carbon formation reaction, or the exothermic reaction can occur in the conduits and tubes while the DRM reaction occurs in the reaction vessel. In some aspects, the heat from the carbon formation reaction can be transferred to the endothermic reaction using a separate heat exchanger to transfer heat from the products of the exothermic reaction to the reactants of the endothermic reaction prior to the reactants entering a separate reactor vessel. In still other configurations, the heat from the carbon formation reaction can be transferred to the endothermic reaction using heat exchange surfaces within the endothermic reactor to transfer heat from the products of the exothermic reaction to the endothermic reactor vessel. In any of these configurations, heat from the exothermic reaction that produces solid carbon can be transferred to an endothermic reaction.

The gas phase products from the carbon formation reaction can pass out of the heat integrated reactor 302 to a condenser 204. The condenser 204 can cool the product stream to condense at least a portion of the water. If any solids are present in the gas phase stream (e.g., the solid carbon, catalyst particles, heat carrier particles, etc.), one or more solid separators can be used between the carbon formation reaction and the condenser 204. The remaining gas phase products from the condenser can pass to an optional separation train, and/or pass back to a compressor to recompress the gas phase components before returning then in recycle stream 319 back to the inlet of the carbon formation reactor.

When the optional separation train is used, all or a portion of the gas phase products can pass to a CO separation unit 208. The separated CO can be recycled to the compressor 206. The remaining gas phase components can pass to a CO₂ separation unit 210, which can return the captured CO₂ back to a compressor 301, which can then pass the compressed CO₂ back to the feed to the DRM reaction in the heat integrated reactor 302. The CO separation unit 208 and the CO₂ separation unit 210 can comprise any suitable units configured to separate CO and/or CO₂, where the CO separation unit 208. Various units such as solvent based contactors can be used to separate CO and/or CO₂ from the gas phase product stream.

The remaining gas phase products may generally comprise unreacted hydrocarbons with some trace amounts of water, CO, CO₂, and H₂. The stream can pass to the second reactor 314 as a fuel stream 303 where it can be combined with a source of oxygen such as air or an enhanced oxygen stream to allow for combustion to provide heat to the endothermic reactions in the second reactor 314.

Overall, the system 300 and corresponding process as shown in FIG. 3 can be used to convert a hydrocarbon to solid carbon and hydrogen while integrating the heat from one or more exothermic reactions that produce solid carbon with endothermic reactions used to produce the intermediates in the conversion process.

Having described various systems and methods, certain aspects include, but are not limited to:

A first aspect, a heat integrated reaction process comprises: carrying out one or more exothermic reactions to produce heat and form solid carbon from a reactant gas comprising CO, a hydrocarbon, and CO₂; transferring at least a portion of the heat from the one or more exothermic reactions to at least one endothermic reaction of one or more endothermic reactions; and carrying out the one or more endothermic reactions using the heat transferred from the one or more exothermic reactions.

A second aspect can include the process of the first aspect, wherein the one or more exothermic reactions comprise a CO reduction reaction.

A third aspect can include the process of the first or second aspect, wherein the one or more exothermic reactions comprise a Boudouard reaction.

A fourth aspect can include the process of any one of the first to third aspects, wherein the one or more exothermic reactions comprise a CO₂ reduction reaction.

A fifth aspect can include the process of any one of the first to fourth aspects, where in the one or more exothermic reactions comprise a hydrocarbon reacting with O₂ to form the solid carbon along with gas species comprising CO, CO₂, and H₂O.

A sixth aspect can include the process of any one of the first to fifth aspects, wherein the one or more exothermic reactions are occurring in a fluidized bed containing solid carbon, metal, metal oxides, and/or metal carbides.

A seventh aspect can include the process of the sixth aspect, wherein a metal of the metal, metal oxides, and/or metal carbides comprises at least one of Fe, Mn, Co, Ni, Si, Mg, Ca, Na, Al, Ti, Pt, Pd, Rh, Ru, or any combination thereof.

An eighth aspect can include the process of any one of the first to seventh aspects, wherein the one or more endothermic reactions comprise a steam methane reforming reaction.

A ninth aspect can include the process of any one of the first to eighth aspects, wherein the one or more endothermic reactions comprise a dry reforming of methane reaction.

A tenth aspect can include the process of any one of the first to ninth aspects, wherein the one or more endothermic reactions comprise a hydrocarbon pyrolysis reaction.

An eleventh aspect can include the process of any one of the first to tenth aspects, wherein the one or more endothermic reactions comprise a reverse water gas shift reaction.

A twelfth aspect can include the process of any one of the first to eleventh aspects, wherein the one or more endothermic reactions comprise a steam gasification of carbon reaction.

A thirteenth aspect can include the process of any one of the first to twelfth aspects, wherein the one or more endothermic reactions comprise a reverse Boudouard reaction.

A fourteenth aspect can include the process of any one of the first to thirteenth aspects, wherein the one or more exothermic reactions occur at a temperature between 400-1000 °C.

A fifteenth aspect can include the process of any one of the first to fourteenth aspects, wherein the one or more exothermic reactions occur at a pressure between about 1-50 bar.

A sixteenth aspect can include the process of any one of the first to fifteenth aspects, wherein the one or more endothermic reactions occur at a pressure between about 1-50 bar.

A seventeenth aspect can include the process of any one of the first to sixteenth aspects, wherein the one or more endothermic reactions occur at a pressure that is greater than a pressure at which the one or more exothermic reactions occur.

An eighteenth aspect can include the process of any one of the first to seventeenth aspects, wherein the one or more endothermic reactions occur at a pressure that is less than a pressure at which the one or more exothermic reactions occur.

A nineteenth aspect can include the process of any one of the first to eighteenth aspects, wherein the one or more endothermic reactions occur at a pressure that is about the same as a pressure at which the one or more exothermic reactions occur.

A twentieth aspect can include the process of any one of the first to nineteenth aspects, wherein transferring the heat to the at least one endothermic reaction occurs within an exothermic reactor carrying out the one or more exothermic reactions.

A twenty first aspect can include the process of any one of the first to twentieth aspects, wherein transferring the heat to the at least one endothermic reaction occurs outside of an exothermic reactor carrying out the one or more exothermic reactions.

In a twenty second aspect, a system to convert hydrocarbons to solid carbon and hydrogen comprises: a first reactor configured to at least partially convert hydrocarbons with H₂O and/or CO₂ to a first product stream comprising CO, CO₂, H₂O, and H₂; a second reactor configured to receive the first product stream and further convert the first product stream to produce a second product stream; a third reactor configured to receive the second product stream, carry out an exothermic reaction and convert at least a portion of CO and CO₂ in the second product stream to solid carbon, wherein at least a portion of the heat released in the exothermic reaction is transferred to the first reactor.

A twenty third aspect can include the system of the twenty second aspect, further comprising: a water separation unit, wherein the water separation unit is configured to separate at least a portion of the water in the second product stream; and a hydrogen separation unit, wherein the hydrogen separation unit is configured to separate at least a portion of the hydrogen from the second product stream, wherein the second product stream having the portion of the water removed and the portion of the hydrogen removed forms the second product stream received by the third reactor.

A twenty fourth aspect can include the system of the twenty second or twenty third aspect, wherein the second reactor is configured to be heated by combusting H₂.

A twenty fifth aspect can include the system of any one of the twenty second to twenty fourth aspects, wherein the hydrocarbons comprise methane, natural gas, ethanol, naphtha, crude oil, biomass, or any combination thereof.

A twenty sixth aspect can include the system of any one of the twenty second to twenty fifth aspects, wherein the first reactor, the second reactor, and the third reactor are each configured to operate at a pressure between 1-50 bar or about 5-20 bar.

A twenty seventh aspect can include the system of any one of the twenty second to twenty sixth aspects, wherein the first reactor and the second reactor are each configured to operate at a different pressure than the third reactor.

A twenty eighth aspect can include the system of any one of the twenty second to twenty seventh aspects, wherein the first reactor and the second reactor are configured to operate at a temperature between 400 °C-1000 °C.

A twenty ninth aspect can include the system of any one of the twenty second to twenty eighth aspects, wherein the third reactor comprises a fluidized bed.

A thirtieth aspect can include the system of any one of the twenty second to twenty ninth aspects, wherein the third reactor is a fluidized bed reactor containing a metal or metal carbide catalyst.

A thirty first aspect can include the system of the thirtieth aspect, wherein the metal or metal carbide catalyst comprises Fe, Mn, Co, Ni, Si, Mg, Ca, Na, Al, Ti, Pt, Pd, Rh, Ru, or any combination thereof.

A thirty second aspect can include the system of any one of the twenty second to thirty first aspects, wherein the first reactor, the second reactor, or both comprise a catalyst, and wherein the catalyst comprises Fe, Mn, Co, Ni, Si, Mg, Ca, Na, Al, Ti, Pt, Pd, Rh, Ru, or any combination thereof.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

1. A heat integrated reaction process comprising:
carrying out one or more exothermic reactions to produce heat and form solid carbon from a reactant gas comprising CO, a hydrocarbon, and CO₂;
transferring at least a portion of the heat from the one or more exothermic reactions to at least one endothermic reaction of one or more endothermic reactions; and
carrying out the one or more endothermic reactions using the heat transferred from the one or more exothermic reactions.

2. The process of claim 1, wherein the one or more exothermic reactions comprise at least one of: a CO reduction reaction, a Boudouard reaction, or a CO₂ reduction reaction.

3.-4. (canceled)

5. The process of claim 1, where in the one or more exothermic reactions comprise a hydrocarbon reacting with O₂ to form the solid carbon along with gas species comprising CO, CO₂, and H₂O.

6. The process of claim 1, wherein the one or more exothermic reactions are occurring in a fluidized bed containing solid carbon, metal, metal oxides, and/or metal carbides.

7. The process of claim 6, wherein a metal of the metal, metal oxides, and/or metal carbides comprises at least one of Fe, Mn, Co, Ni, Si, Mg, Ca, Na, Al, Ti, Pt, Pd, Rh, Ru, or any combination thereof.

8. The process of claim 1, wherein the one or more endothermic reactions comprise at least one of: a steam methane reforming reaction, a dry reforming of methane reaction, a hydrocarbon pyrolysis reaction, a reverse water gas shift reaction, a steam gasification of carbon reaction, or a reverse Boudouard reaction.

9.-13. (canceled)

14. The process of claim 1, wherein the one or more exothermic reactions occur at a temperature between 400-1000 °C.

15. The process of claim 1, wherein the one or more exothermic reactions occur at a pressure between about 1-50 bar, and wherein the one or more endothermic reactions occur at a pressure between about 1-50 bar.

16. (canceled)

17. The process of claim 1, wherein the one or more endothermic reactions occur at a pressure that is greater than a pressure at which the one or more exothermic reactions occur.

18. The process of claim 1, wherein the one or more endothermic reactions occur at a pressure that is less than a pressure at which the one or more exothermic reactions occur.

19. The process of claim 1, wherein the one or more endothermic reactions occur at a pressure that is about the same as a pressure at which the one or more exothermic reactions occur.

20. The process of claim 1, wherein transferring the heat to the at least one endothermic reaction occurs within an exothermic reactor carrying out the one or more exothermic reactions.

21. The process of claim 1, wherein transferring the heat to the at least one endothermic reaction occurs outside of an exothermic reactor carrying out the one or more exothermic reactions.

22. A system to convert hydrocarbons to solid carbon and hydrogen, the system comprising:
a first reactor configured to at least partially convert hydrocarbons with H₂O and/or CO₂ to a first product stream comprising CO, CO₂, H₂O, and H₂;
a second reactor configured to receive the first product stream and further convert the first product stream to produce a second product stream;
a third reactor configured to receive the second product stream, carry out an exothermic reaction and convert at least a portion of CO and CO₂ in the second product stream to solid carbon, wherein at least a portion of the heat released in the exothermic reaction is transferred to the first reactor.

23. The system of claim 22, further comprising:
a water separation unit, wherein the water separation unit is configured to separate at least a portion of the water in the second product stream; and
a hydrogen separation unit, wherein the hydrogen separation unit is configured to separate at least a portion of the hydrogen from the second product stream, wherein the second product stream having the portion of the water removed and the portion of the hydrogen removed forms the second product stream received by the third reactor.

24. The system of claim 22, wherein the second reactor is configured to be heated by combusting H₂.

25. The system of claim 22, wherein the hydrocarbons comprise methane, natural gas, ethanol, naphtha, crude oil, biomass, or any combination thereof.

26. The system of claim 22, wherein the first reactor, the second reactor, and the third reactor are each configured to operate at a pressure between 1-50 bar or about 5-20 bar.

27. The system of claim 22, wherein the first reactor and the second reactor are each configured to operate at a different pressure than the third reactor.

28. The system of claim 22, wherein the first reactor and the second reactor are configured to operate at a temperature between 400 °C-1000 °C.

29. The system of claim 22, wherein the third reactor comprises a fluidized bed.

30. The system of claim 22, wherein the third reactor is a fluidized bed reactor containing a metal or metal carbide catalyst.

31. The system of claim 30, wherein the metal or metal carbide catalyst comprises Fe, Mn, Co, Ni, Si, Mg, Ca, Na, Al, Ti, Pt, Pd, Rh, Ru, or any combination thereof.

32. The system of claim 22, wherein the first reactor, the second reactor, or both comprise a catalyst, and wherein the catalyst comprises Fe, Mn, Co, Ni, Si, Mg, Ca, Na, Al, Ti, Pt, Pd, Rh, Ru, or any combination thereof.
